(19) United States
(12) Patent Application Publication
(10) Pub. No.: US 2010/0231668 A1
(43) Pub. Date: Sep. 16, 2010

(54) BUBBLE REMOVING METHOD

(75) Inventor: Hiroyuki ITO, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/721,166

(22) Filed: Mar. 10, 2010

(30) Foreign Application Priority Data
Mar. 11, 2009 (JP) 2009-057823

(51) Int. Cl. B41J 2/19

(52) U.S. Cl. 347/92

(57) ABSTRACT

A method removes bubbles from a liquid in a liquid ejecting apparatus. The liquid ejecting apparatus includes a liquid storing chamber that stores a liquid and a first pressure control chamber adjacent to the liquid storing chamber with a first partition wall portion having flexibility and gas permeability interposed therebetween. A pressure control valve opens or seals an inlet of the liquid storing chamber in response to displacement of the first partition wall portion. A switching valve connects to the first pressure control chamber. A depressurizing pump is connected to the switching valve. An ejection port on the downstream side of the liquid storing chamber ejects the liquid. The method includes communicating the first pressure control chamber with the depressurizing pump by controlling the switching valve, depressurizing the first pressure control chamber by driving the depressurizing pump, and sealing the first pressure control chamber by controlling the switching valve.

This application claims the benefit of Japanese Patent Application No. 2009-057823, filed Mar. 11, 2009, which is expressly incorporated herein by reference in its entirety.

### BACKGROUND

1. Technical Field

The present invention relates to a technology of removing bubbles from a liquid flowing in a liquid ejecting apparatus.

2. Related Art

In an ink jet printer of an off-carriage type in which an ink cartridge is mounted to a printer body, in the case where a layout is adopted in which a head (nozzle plate) is disposed at a position lower than the ink cartridge, it is necessary to suppress a leakage of ink from nozzles due to a water head difference. Here, there is proposed a printer which suppresses an ink leakage by depressurizing an ink channel inside a head and supplies a corresponding amount of ink to be ejected to the head when ink is ejected from a nozzle. For example, JP-A-2005-186344 proposes a printer in which an ink storing chamber is provided in a head, and a pressure control valve (which is opened when the pressure inside the ink storing chamber is decreased due to an ink ejecting operation and is closed when the pressure inside the ink storing chamber is increased due to an inflow of ink corresponding to an ejection amount) is provided in an inlet of the ink storing chamber.

In the technology using the pressure control valve, since the structure of the pressure control valve is complex, bubbles contained in ink easily stay in the vicinity of the pressure control valve. For this reason, in the case where the bubbles stay without performing the printing operation for some time, the bubbles grow, and hence large bubbles may exist in the ink storing chamber. In this case, the large bubbles may flow into the nozzles together with ink during a printing operation, and may cause a printing error such as a dot omission. In addition, the above-described problem may arise in a liquid ejecting apparatus for ejecting an arbitrary liquid such as lubricant or resin liquid as well as the ink jet printer.

### SUMMARY

An advantage of some aspects of the invention is that it provides a liquid ejecting apparatus which includes a pressure control valve provided in an inlet of a liquid storing chamber and removes bubbles contained in the liquid storing chamber.

At least a part of the above-described object is realized by the embodiment or application described below.

### Application 1

There is provided a bubble removing method of removing bubbles contained in a liquid in a liquid ejecting apparatus including: a liquid storing chamber which stores a liquid, a first pressure control chamber which is adjacent to the liquid storing chamber with a first partition wall portion having flexibility and gas permeability interposed therebetween, a pressure control valve which opens or seals an inlet of the liquid storing chamber in response to displacement of the first partition wall portion, a switching valve which is connected to the first pressure control chamber, a depressurizing pump which is connected to the switching valve, and an ejection port which is disposed on the downstream side of the liquid storing chamber to eject the liquid, the bubble removing method including: communicating the first pressure control chamber with the depressurizing pump by controlling the switching valve; depressurizing the first pressure control chamber by driving the depressurizing pump; and sealing the first pressure control chamber by controlling the switching valve.

In the bubble removing method according to the application 1, since the first pressure control chamber communicates with the depressurizing pump and the depressurizing pump is driven so that the first pressure control chamber is sealed, it is possible to maintain the depressurized state of the first pressure control chamber. Accordingly, it is possible to remove the bubbles in such a manner that the bubbles contained in the liquid storing chamber are continuously made to pass through the first partition wall portion and to flow into the first pressure control chamber.

### Application 2

The bubble removing method according to the application 1, further includes: sucking the ejection port; and opening the first pressure control chamber to an atmosphere.

With such a configuration, the ejection port is sucked in the state where the first pressure control chamber is sealed to be in a depressurized state, and the first pressure control chamber is opened to the atmosphere. Accordingly, it is possible to abruptly displace the first partition wall portion toward the liquid storing chamber, and to decrease a force applied to the liquid on the downstream side of the pressure control valve toward the first pressure control chamber. As a result, it is possible to allow the liquid on the downstream side of the pressure control valve to vigorously flow toward the ejection port by using the displacement of the first partition wall portion and the suction force of the ejection port, and thus to discharge a large amount of liquid or bubbles remaining in the ejection port.

### BRIEF DESCRIPTION OF THE DRAWINGS

The invention will be described with reference to the accompanying drawings, wherein like numbers reference like elements.

FIG. 1 is an explanatory diagram illustrating a schematic configuration of a printer including a carriage as a bubble removing mechanism according to the invention.

FIGS. 2A and 2B are explanatory diagrams illustrating a detailed configuration of a printing head and the carriage during an ink ejection and after an ink supply.

FIG. 3 is a flowchart illustrating a sequence of a bubble removing process performed in the printer.

FIGS. 4A and 4B are explanatory diagrams schematically illustrating sections of the printing head and the carriage upon performing Step S110 and Step S115 in the bubble removing process.

FIG. 5 is an explanatory diagram illustrating a schematic configuration of a printer according to a second embodiment.

FIG. 6 is a flowchart illustrating a sequence of a bubble removing process according to the second embodiment.

FIG. 7 is an explanatory diagram schematically illustrating sections of the printing head and the carriage after performing Step S125.

FIG. 8 is an explanatory diagram schematically illustrating sections of the printing head and the carriage according to a third embodiment.

### DESCRIPTION OF EXEMPLARY EMBODIMENTS

### A. First Embodiment

### A1. Configuration of Apparatus

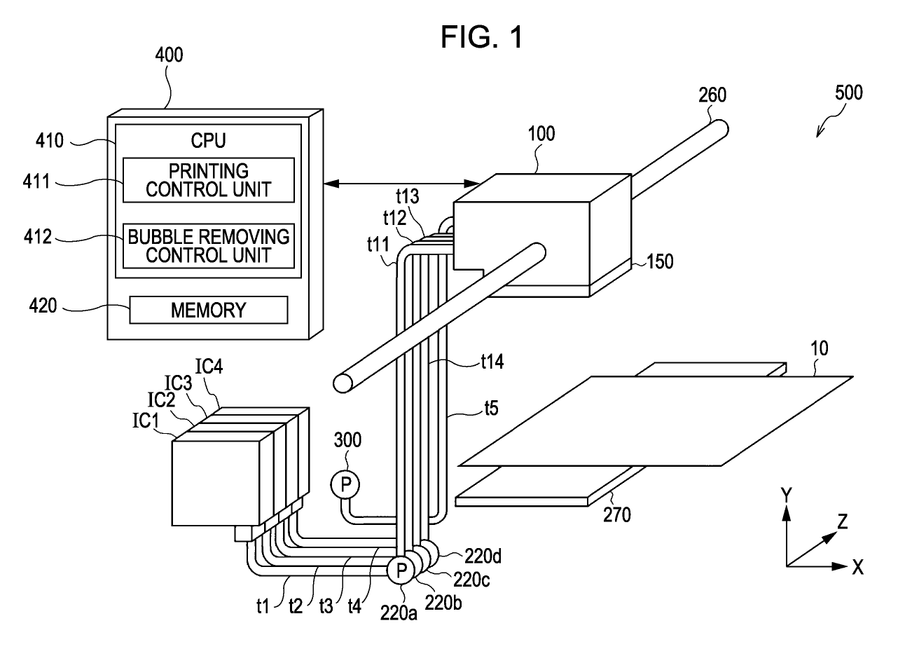

FIG. 1 is an explanatory diagram illustrating a schematic configuration of a printer 500 including a carriage 100 as a bubble removing mechanism according to the invention. The printer 500 is an ink jet printer capable of ejecting four colors (black, cyan, magenta, and yellow) of ink. The printer 500 includes an ink cartridge IC1 of black ink, an ink cartridge IC2 of cyan ink, an ink cartridge IC3 of magenta ink, an ink cartridge IC4 of yellow ink, the carriage 100, a printing head 150, four ink supply pumps 220a, 220b, 220c, and 220d, a depressurizing pump 300, a guide rod 260, a platen 270, and a control substrate 400.

The printer 500 is a so-called off-carriage type printer in which four ink cartridges IC1 to IC4 are attached to a printer body. The ink cartridge IC1 is connected to the carriage 100 through a tube t1, the ink supply pump 220a, and a tube t11. In the same manner, the ink cartridge IC2 is connected to the carriage 100 through a tube t2, the ink supply pump 220b, and a tube t12, the ink cartridge IC3 is connected to the carriage 100 through a tube t3, the ink supply pump 220c, and a tube t13, and the ink cartridge IC4 is connected to the carriage 100 through a tube t4, the ink supply pump 220d, and a tube t14. The depressurizing pump 300 is connected to the carriage 100 through a tube t5. In addition, the ink cartridges IC1 to IC4 are attached to a body frame (not shown) of the printer 500 through a cartridge holder (not shown).

The ink supply pump 220a supplies the black ink stored in the ink cartridge IC1 to the cartridge 100 in a pressurized state. In the same manner, the ink supply pump 220b supplies the cyan ink stored in the ink cartridge IC2 to the carriage 100 in a pressurized state, the ink supply pump 220c supplies the magenta ink stored in the ink cartridge IC3 to the carriage 100 in a pressurized state, and the ink supply pump 220d supplies the yellow ink stored in the ink cartridge IC4 to the carriage 100 in a pressurized state. The depressurizing pump 300 performs a suction operation through the tube t5 in a driven state. In addition, the tube t5 is opened to the atmosphere in a state where the first depressurizing pump 300 is stopped. The depressurizing pump 300 is commonly used for each color (black, cyan, magenta, and yellow).

The guide rod 260 is disposed along the longitudinal direction (Z-axis direction) of the platen 270 above the platen 270. The carriage 100 is supported so as to be movable along the guide rod 260 in the longitudinal direction of the platen 270, and is driven by a carriage motor (not shown) through a timing belt (not shown). The printing head 150 is disposed on the bottom surface of the carriage 100, and ink droplets are ejected from a plurality of nozzles (not shown) in accordance with a reciprocating movement of the carriage 100 in the longitudinal direction. At this time, when a printing sheet P is transported on the platen 270 by a sheet transporting mechanism (not shown), an image or the like is formed on the printing sheet P.

The control substrate 400 includes a CPU (Central Processing Unit) 410 and a memory 420. The control substrate 400 is electrically connected to the carriage 100 or various pumps such as the depressurizing pump 300. The memory 420 stores a printing control program and a bubble removing control program, and the CPU 410 serves as a printing control unit 411 by executing the printing control program. The printing control unit 411 controls an ink ejection by controlling the printing head 150 or four ink supply pumps 220a, 220b, 220c, and 220d. In the same manner, the CPU 410 serves as a bubble removing control unit 412 by executing the bubble removing control program. The bubble removing control unit 412 performs the bubble removing process to be described later.

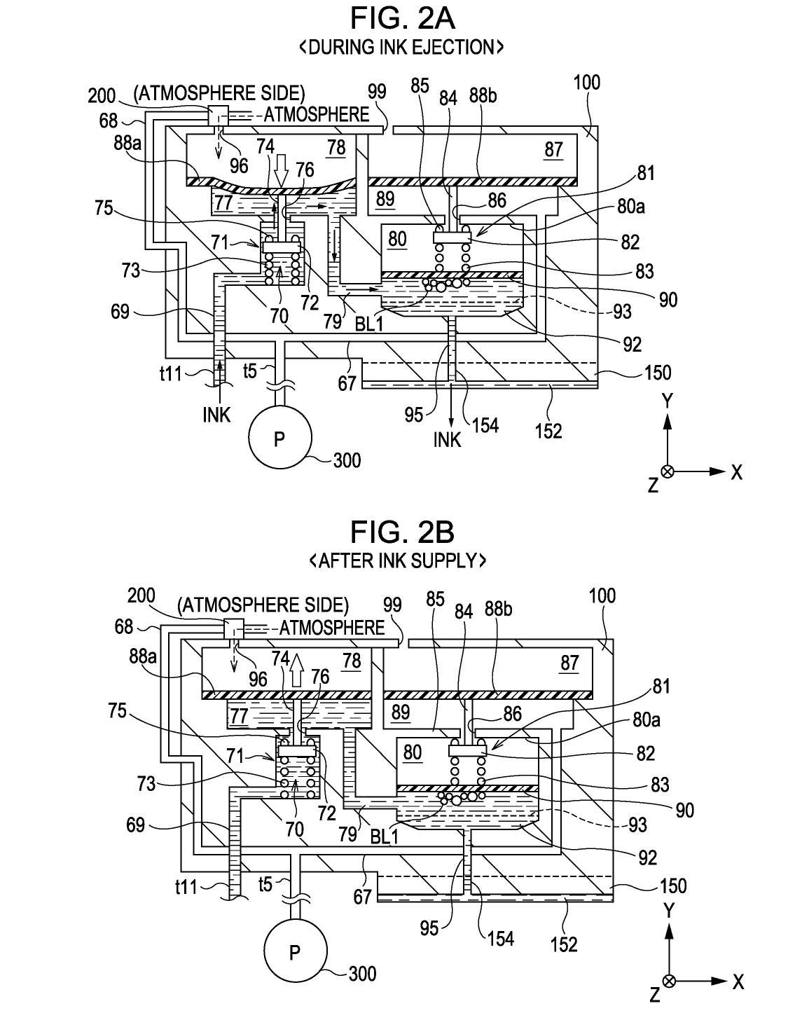

FIG. 2A is an explanatory diagram illustrating a detailed configuration of the carriage 100 and the printing head 150 and the carriage 100 during the ink ejection. FIG. 2B is an explanatory diagram illustrating a detailed configuration of the carriage 100 and the printing head 150 after the ink supply. In FIGS. 2A and 2B, sections of the carriage 100 and the printing head 150 are schematically shown. In addition, in the state where the printer 500 is placed, the upward vertical direction aligns with the +Y direction. In FIGS. 2A and 2B, a function portion involved with the black ink is shown, but the same applies to the function portions involved with other colors of inks.

As shown in FIG. 2A, the carriage 100 includes a first atmosphere chamber 78, a fist partition wall portion 88a, a first pressure chamber 77, a valve chamber 70, a first pressure control valve 71, a bubble removing chamber 92, a bubble removing partition wall portion 90, a depressurizing chamber 80, a second pressure chamber 89, a second partition wall portion 88b, a second atmosphere chamber 87, a second pressure control valve 81, two ink channels 69 and 79, two negative pressure supply paths 67 and 68, and a switching valve 200.

The first partition wall portion 88a is disposed in the bottom portion of the first atmosphere chamber 78, and the ceiling portion facing the first partition wall portion 88a is provided with a gas communication hole 96. The first partition wall portion 88a includes a sheet-like member having gas permeability and flexibility and a displaceable cantilever thin plate member (not shown). As the sheet-like member, for example, a thin film such as polyacetal, polypropylene, or polyphenyleneether (PPE) may be adopted. The first partition wall portion 88a forms the bottom surface of the first atmosphere chamber 78 and also forms the ceiling surface of the first pressure chamber 77.

The first pressure chamber 77 temporarily collects the black ink supplied to the bubble removing chamber 92. The first pressure chamber 77 communicates with the bubble removing chamber 92 through the ink channel 79. In addition, the first pressure chamber 77 includes an ink inlet 76, and communicates with the valve chamber 70 to be described later through the ink inlet 76. The valve chamber 70 accommodates the first pressure control valve 71, and communicates with the ink channel 69.

The first pressure control valve 71 is used to control a flow rate and a pressure of the black ink. The first pressure control valve 71 includes a pressure control spring 73, a valve body 72, a seal member 75, and a support rod 74. The pressure control spring 73 is connected to the bottom surface of the valve chamber 70 and the lower surface of the valve body 72, and urges the valve body 72 in a direction in which the valve body 72 comes into contact with the ceiling surface of the valve chamber 70. The valve body 72 is displaceable between an opening position where the first pressure chamber 77 communicates with the valve chamber 70 and a sealing position where the communication is not permitted in accordance with expansion and contraction operations of the pressure control spring 73. In detail, when the ink is discharged from the first pressure chamber 77 so that a force (a pressing force of the support rod 74 generated by the partition wall 88a and a pressure inside the first pressure chamber 77) pressing down the valve body 72 is larger than a force (a pressure inside the valve chamber 70 and an urging force of the pressure control spring 73) pressing up the valve body 72, the valve body 72 displaces toward the opening position. In addition, when the ink flows into the first pressure chamber 77 so that a force pressing down the valve body is smaller than a force pressing up the valve body 72, the valve body 72 displaces toward the sealing position. Further, in an example shown in FIG. 2A, the valve body 72 is located at the opening position, and in an example of FIG. 2B, the valve body is located at the sealing position. The seam member 75 is disposed on the upper surface of the valve body 72, and seals the valve body 72 at the sealing position so that the ink does not flow from the valve chamber 70 to the first pressure chamber 77. The support rod 74 is disposed from the valve chamber 70 and the first pressure chamber 77 so that one end is bonded to the valve body 72 and the other end is bonded to the partition wall portion 88a. Accordingly, when the support rod 74 displaces in the vertical direction in accordance with the vertical displacement of the first partition wall portion 88a, the first pressure control valve 71 opens or seals the ink inlet 76.

The bubble removing chamber 92 temporarily stores the ink flowing from the ink channel 79, and collects bubbles in the ink into the bubble removing partition wall portion 90 to be described later. The bubble removing chamber 92 includes a filter 93, and communicates with the ink channel 79 above the filter 93. In addition, the bubble removing chamber 92 also communicates with the ink channel 95. The filter 93 filters impurities contained in the ink, and also suppress large bubbles from flowing into the printing head 150.

The bubble removing partition wall portion 90 is formed as a sheet-like member having gas permeability, and the bubbles captured in the bubble removing chamber 92 pass therethrough so as to flow into the depressurizing chamber 80. The edge of the bubble removing partition wall portion 90 is adhered to the side surface of the upper end of the bubble removing chamber 92 so as to form the ceiling surface of the bubble removing chamber 92 and to also form the bottom surface of the depressurizing chamber 80.

The depressurizing chamber 80 is a chamber for receiving bubbles (gases) passing through the bubble removing partition wall portion 90. The depressurizing chamber 80 is adjacent to the upper portion of the bubble removing chamber 92 with the bubble removing partition wall portion 90 interposed therebetween. The depressurizing chamber 80 includes a communication hole 86 formed in the ceiling surface 80a (a surface opposite to a surface provided with the bubble removing partition wall portion 90), and communicates with the second pressure chamber 89 through the communication hole 86.

The second pressure chamber 89 is used to supply a negative pressure, supplied form the depressurizing chamber 300, to the depressurizing chamber 80. The second pressure chamber 89 is disposed above the depressurizing chamber 80, and is connected to the tube t5 through a negative pressure supply path 67. The second pressure chamber 89 is disposed so as to be adjacent to the second atmosphere chamber 87 with the partition wall portion 88b forming the ceiling portion interposed therebetween. The second partition wall portion 88b has the same configuration as that of the first partition wall portion 88a. The second partition wall portion 88b is disposed at the bottom portion of the second atmosphere chamber 87, and the ceiling portion facing the second partition wall portion 88b is provided with an atmosphere communication hole 99.

The second pressure control valve 81 is included in the second pressure chamber 89 and the depressurizing chamber 80, and allows the second pressure chamber 89 and the depressurizing chamber 80 to be in a communication state or a non-communication state. The second pressure control valve 81 has the same configuration as that of the first pressure control valve 71. That is, the second pressure control valve 81 includes a valve body 82, a pressure control spring 83, a seal member 85, and a support rod 84. The valve body 82 is displaceable between an opening position where the second pressure chamber 89 communicates with the depressurizing chamber 80 and a sealing position where the communication is not permitted, and is urged toward the sealing position by the pressure control spring 83. In the examples of FIGS. 2A and 2B, the valve body 82 is disposed at the sealing position. When the valve body 82 is disposed at the sealing position, the seal member 85 seals the communication hole 86, and maintains a pressure inside the depressurizing chamber 80. One end of the support rod 84 is bonded to the valve body 82, and the other end thereof is bonded to the partition wall portion 88b.

The switching valve 200 is a three-way electromagnetic valve, where a first connection port is connected to the first atmosphere chamber 78 through the gas communication hole 96, a second connection port is connected to the depressurizing pump 300 through the negative pressure supply path 68, and a third connection port is opened to the atmosphere. The switching valve 200 changes a communication state of the first atmosphere chamber 78 by an operation of opening or closing the valve. In detail, the switching valve 200 selects an arbitrary state among three states, that is, a state where the first atmosphere chamber 78 communicates with the atmosphere, a state where the first atmosphere chamber 78 communicates with the depressurizing pump 300, and a state where the first atmosphere chamber 78 is sealed. In addition, the operation of opening or closing the valve in the switching valve 200 is controlled by the printing control unit 411 or the bubble removing control unit 412.

The printing head 150 is disposed on the bottom surface of the carriage 100, and ejects ink toward a printing sheet P (FIG. 1). The printing head 150 includes a nozzle plate 152 and an ink ejecting channel 154. The ink ejecting channel 154 communicates with the ink channel 95 of the carriage 100 so as to guide the ink discharged from the bubble removing chamber 92 toward the nozzle plate 152. The nozzle plate 152 includes a plurality of nozzles (not shown).

The first pressure chamber 77 corresponds to a liquid storing chamber according to claim. In addition, the first partition wall portion 88a corresponds to a first partition wall portion according to claim, the first atmosphere chamber 78 corresponds to a first pressure control chamber according to claim, the first pressure control valve 71 corresponds to a pressure control valve according to claim, and the nozzle included in the nozzle plate 152 corresponds to an ejection port according to claim.

### A2. Ink Supply Operation

Hereinafter, an operation of supplying ink to the carriage 100 will be described with reference to FIGS. 2A and 2B. When ink is consumed by ejecting ink from nozzles (not shown) provided in the nozzle plate 152 in the state where the first atmosphere chamber 78 communicates with the atmosphere, as shown in FIG. 2A, an amount of ink inside the first pressure chamber 77 decreases, and hence a pressure of the first pressure chamber 77 decreases. Then, a pressure of the first pressure chamber 77 becomes lower than that of a pressure (atmospheric pressure) of the atmosphere chamber 87, and the partition wall portion 88b is bent to the inside of the first pressure chamber 77 due to a difference in pressure so as to displace to the lower portion.

Accordingly, the valve body 72 may be pressed down by the support rod 74. Then, when the valve body 72 is located at the opening position against the urging force of the pressure control spring 73, the ink inlet 76 is opened, and ink flows into the first pressure chamber 77.

When the ink flows into the first pressure chamber 77 so that a pressure of the chamber becomes large, as shown in FIG. 2B, the partition wall portion 88b displaces upward. Accordingly, when the valve body 72 moves again to the sealing position, the stream of the ink into the first pressure chamber 77 is stopped, and hence the ink supply to the printing head 150 is stopped. Likewise, in the printer 500, the first pressure control valve 71 is opened or closed in accordance with the consumption of the ink, so that a consumed amount of ink appropriately flows into the printing head 150.

### A3. Bubble Removing Process

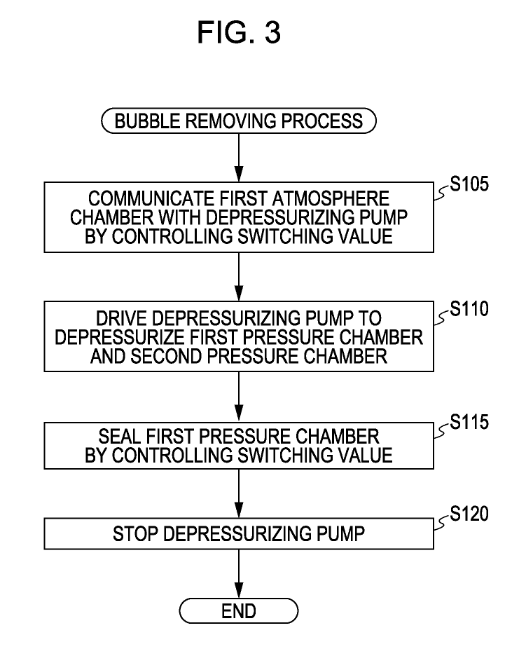

FIG. 3 is a flowchart illustrating a sequence of the bubble removing process performed in the printer 500. The printer 500 performs the bubble removing process when the power is turned off. In addition, when the bubble removing process is started, all the first pressure control valve 71 and the second pressure control valve 81 are in a closed state. First, the bubble removing control unit 412 communicates the first atmosphere chamber 78 with the depressurizing pump 300 by controlling the switching valve 200 (Step S105). Subsequently, the bubble removing control unit 412 depressurizes the first atmosphere chamber 78 and the second pressure chamber 89 by driving the driving the depressurizing pump 300 (Step S110).

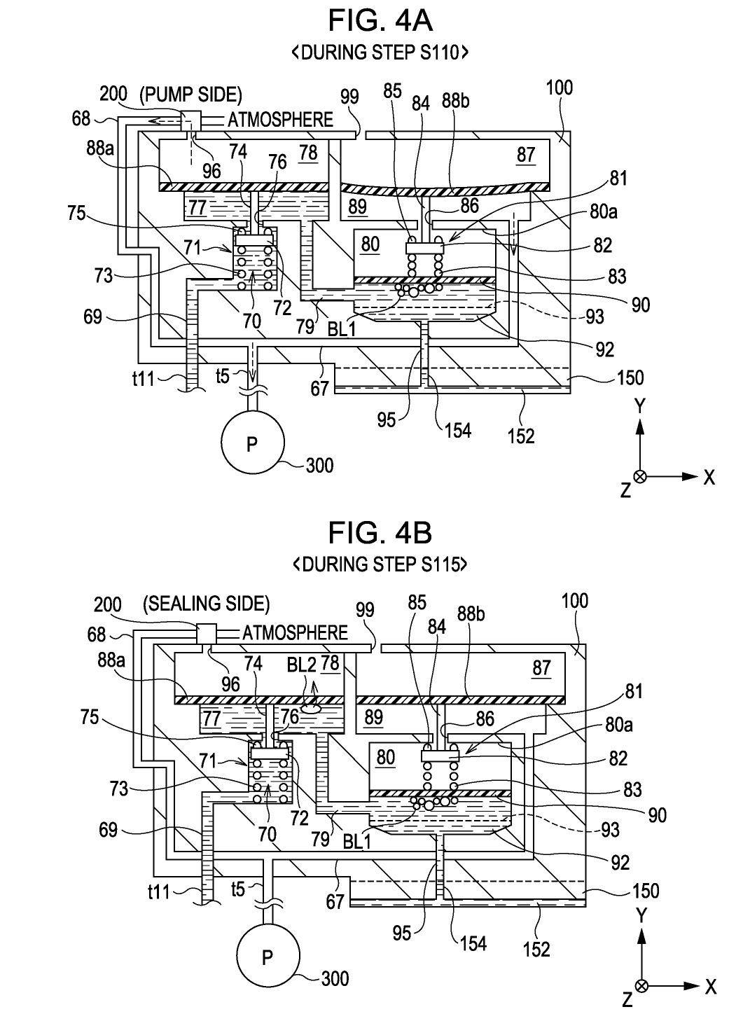

FIG. 4A is an explanatory diagram schematically illustrating the sections of the carriage 100 and the printing head 150 upon performing Step S110. In FIG. 4A, in the state where the printer 500 is placed, the upward vertical direction aligns with the +Y direction as in FIGS. 2A and 2B. Although a function portion involved with the black ink is shown, but the same applies to the function portions involved with other colors of inks.

When the first atmosphere chamber 78 is in a negative pressure state, an upward force (a force in a direction from the first pressure chamber 77 to the first atmosphere chamber 78) applied to the first partition wall portion 88a increases, and the first pressure control valve 71 is maintained in a closed state. On the contrary, when the second pressure chamber 89 is in a negative pressure state, the second pressure control valve 81 is pressed down (in a direction from the second pressure chamber 89 to the depressurizing chamber 80) so as to be in an opened state. Accordingly, the depressurizing chamber 80 is depressurized through the communication hole 86.

Returning to FIG. 3, the bubble removing control unit 412 makes the first atmosphere chamber 78 to be sealed by controlling the switching valve 200 (Step S115), and stops the depressurizing pump 300 (Step S120).

FIG. 4B is an explanatory diagram illustrating the carriage 100 and the printing head 150 upon performing Step S115. Since the first atmosphere chamber 78 is sealed after the depressurization, the first atmosphere chamber 78 is maintained in a negative pressure state. Accordingly, the bubbles BL2 inside the first pressure chamber 77 pass through the first partition wall portion 88a and flows to the first atmosphere chamber 78. In addition, when the depressurizing pump 300 is stopped, the pressure of the second pressure chamber 89 is equal to the atmosphere, and hence the valve body 82 is located at the sealing position so that the depressurizing chamber 80 is sealed. Accordingly, since the depressurizing chamber 80 is maintained in a negative pressure state, the bubbles BL1 inside the bubble removing chamber 92 flows out from the depressurizing chamber 80 through the bubble removing partition wall portion 90.

As described above, in the printer 500 according to the first embodiment, after the first atmosphere chamber 78 is depressurized by the depressurizing pump 300 by controlling the switching valve 200, the first atmosphere chamber 78 is sealed to be maintained in a negative pressure state. Accordingly, it is possible to remove the bubbles staying in the first pressure chamber 77 when the printer 500 is turned off by continuously allowing the bubbles to flow to the first atmosphere chamber 78. Since the circulation of ink is not performed for a long time when the printer 500 is turned off, the bubbles inside the first pressure chamber 77 may largely grow. However, since the bubbles inside the first pressure chamber 77 are continuously removed, it is possible to suppress the growth of the bubbles. Accordingly, when the ink is ejected after turning on the printer 500, it is possible to suppress such a problem that large bubbles are supplied to the nozzles to thereby cause a dot omission.

In addition, since it is possible to remove the bubbles in the first pressure chamber 77 disposed on the upstream side of the bubble removing chamber 92, it is possible to decrease the size of the bubble removing chamber 92. Further, since the depressurizing chamber 80 and the first atmosphere chamber 78 are depressurized by using a single depressurizing pump 300, it is possible to suppress an increase in the manufacture cost of the printer 500 compared with a configuration in which two pumps are provided so as to depressurize each chamber.

### B. Second Embodiment

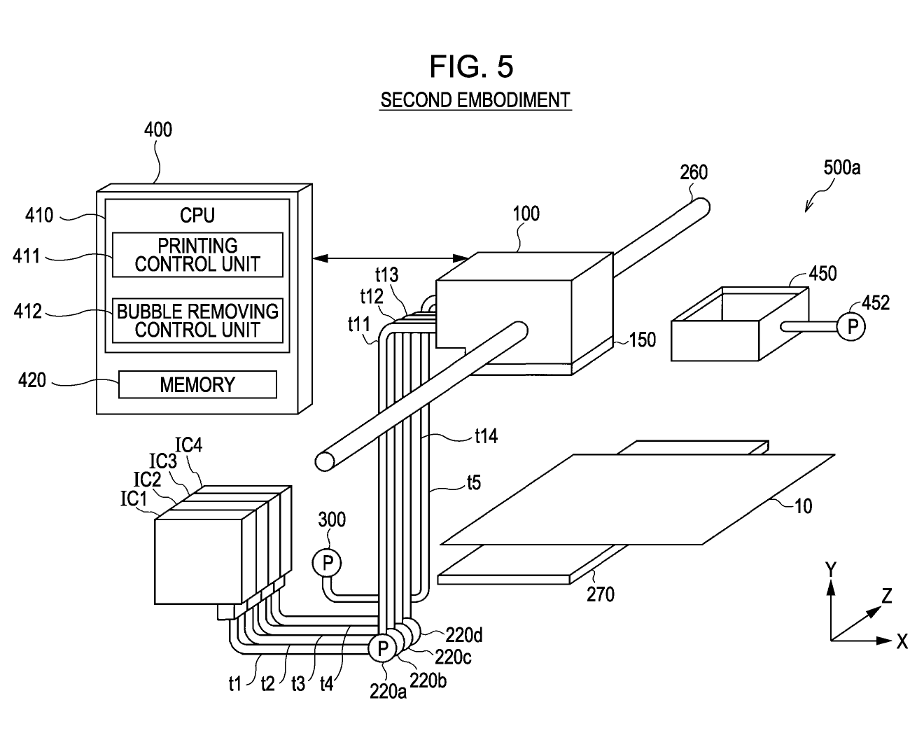

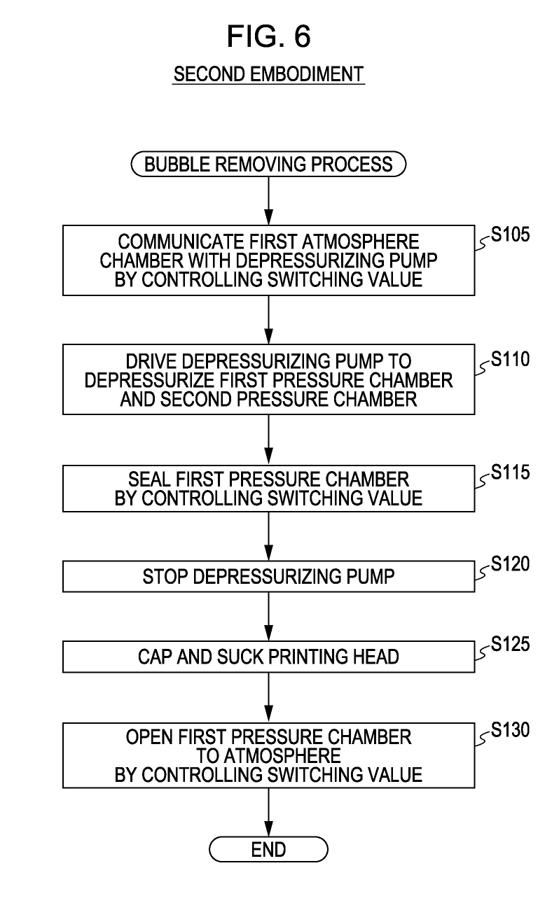

FIG. 5 is an explanatory diagram illustrating a schematic configuration of a printer according to a second embodiment. FIG. 6 is a flowchart illustrating a sequence of a bubble removing process according to the second embodiment.

A printer 500a according to the second embodiment has the same configuration as that of the printer 500 (FIGS. 1 to FIGS. 4A and 4B) according to the first embodiment except that a suction recovery cap 450 and a suction recovery pump 452 are provided, and Step S125 and Step S130 are further performed in the bubble removing process.

The suction recovery cap 450 (FIG. 5) is disposed at a home position of the carriage 100, and is used to receive the ink discharged from the printing head 150 while capping the lower portion of the printing head 150. An ink absorber (not shown) such as a urethane foam is disposed inside the printing head 150, and the ink discharged from the printing head 150 is absorbed by the ink absorber. In addition, a seal member (not shown) such as elastomer is disposed in the upper end of the suction recovery cap 450, and hence a gap between the suction recovery cap 450 and the printing head 150 is maintained to be air-tight when the suction recovery cap 450 caps the printing head 150. The suction recovery pump 452 is connected to the suction recovery cap 450 so as to suck the inside of the suction recovery cap 450.

The suction recovery cap 450 and the suction recovery pump 452 are used to suck and remove the ink from the nozzles (not shown) of the printing head 150. The operation of sucking and removing the ink is performed to remove the bubbles inside the nozzles or to suppress an increase in viscosity caused when the staying ink is dried after the ink is discharged from the nozzles.

In the bubble removing process (FIG. 6) according to the second embodiment, after Step S105 to Step S120 are performed, the bubble removing control unit 412 caps the printing head 150 by using the suction recovery cap 450, and sucks the printing head 150 by driving the suction recovery pump 452 (Step S125).

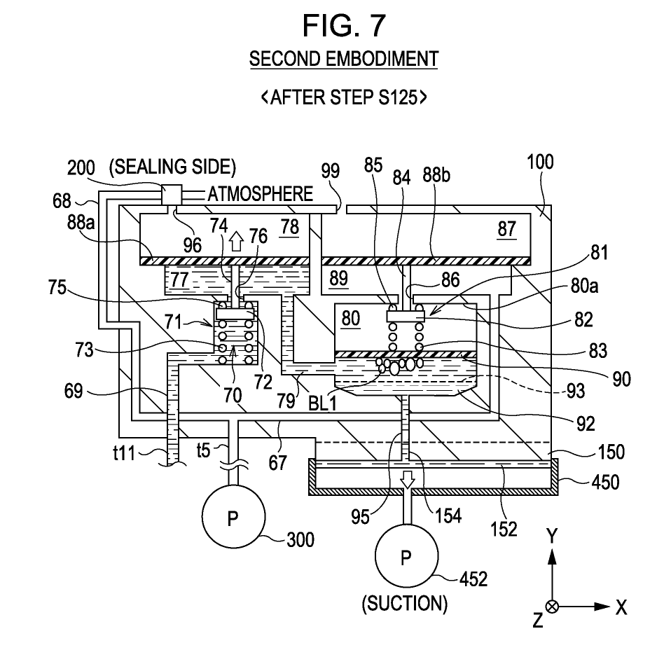

FIG. 7 is an explanatory diagram schematically illustrating the sections of the carriage 100 and the printing head 150 after performing Step S125. As shown in FIG. 7, the suction recovery cap 450 is disposed so as to cover the lower portion of the nozzle plate 152. In Step S115, since the first atmosphere chamber 78 is in a sealed state by the switching valve 200, the first atmosphere chamber 78 is maintained in a negative pressure state. Accordingly, in the case where the printing head 150 is sucked and a negative pressure is supplied to the nozzle plate 152, a force pulling the ink toward the first atmosphere chamber 78 and a force pulling the ink toward the suction recovery cap 450 are applied to the ink on the downstream side of the first pressure control valve 71. In the printer 500a according to the embodiment, the suction force of the suction recovery pump 452 is set in advance by an experiment so that the suction force is equal to a force at which the first pressure control valve 71 is not opened when the printing head 150 is sucked. Accordingly, in the case where Step S125 is performed, the ink ejection is not performed. At this time, the bubbles on the downstream side of the first pressure control valve 71 are expanded by a force pulling the bubbles toward the first atmosphere chamber 78 and a force pulling the bubbles toward the suction recovery cap 450.

Subsequently, the bubble removing control unit 412 allows the first atmosphere chamber 78 to be opened to the atmosphere by controlling the switching valve 200 (Step S130 in FIG. 6). When the first atmosphere chamber 78 is opened to the atmosphere, as in FIG. 2A, the first partition wall portion 88a displaces downward, and the first pressure control valve 71 is opened so that the ink vigorously flows into the first pressure chamber 77. At this time, the ink on the downstream side of the first pressure control valve 71 flows to the ejection direction by the press-down force of the first partition wall portion 88a and the suction force of the suction recovery pump 452, so that the ink is vigorously ejected from the nozzles of the printing head 150. When the first atmosphere chamber 78 is opened to the atmosphere, the bubbles on the downstream side of the first pressure control valve 71 is deformed from the expanded state to the original state. Likewise, since the bubbles itself are deformed, the bubbles staying at the portion where the bubbles easily stay are easily moved by the movement of the bubbles itself due to the deformation, where the portion corresponds to a joint (a component connecting two mechanic components) of the ink channel 79 or a corner of the bubble removing chamber 92. Accordingly, the bubbles move toward the ejection direction in accordance with the stream of the ink. Likewise, the ink or bubbles inside the nozzles are discharged into the suction recovery cap 450 by Step S130.

The printer 500a according to the second embodiment having the above-described configuration has the same advantage as that of the printer 500 according to the first embodiment. In addition, since the first atmosphere chamber 78 is opened to the atmosphere after sucking the printing head 150 in the state where the first atmosphere chamber 78 is maintained in a negative pressure state, it is possible to vigorously eject the ink on the downstream side of the first pressure control valve 71, and thus to discharge a large amount of bubbles or ink inside the nozzles. In addition, since the bubbles on the downstream side of the first pressure control valve 71 are deformed by a variation in the pressure, it is possible to easily move the bubbles staying at the portion where the bubbles easily stay, and thus to remove more bubbles.

### C. Third Embodiment

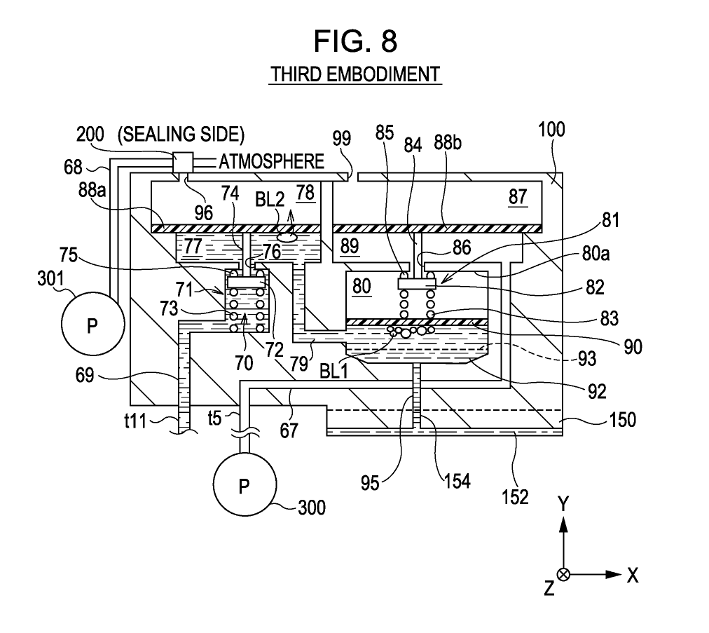

FIG. 8 is an explanatory diagram schematically illustrating the sections of the carriage 100 and the printing head 150 according to a third embodiment. A printer (not shown) according to the third embodiment has the same configuration as that of the printer 500 (FIGS. 1 to 4A and 4B) according to the first embodiment except that an exclusive second depressurizing pump 301 is provided so as to depressurize the first atmosphere chamber 78.

The second depressurizing pump 301 is connected to the switching valve 200 through the negative pressure supply path 68. The second depressurizing pump 301 is controlled by the bubble removing control unit 412 as in the depressurizing pump 300 (simply referred to as a first depressurizing pump). In addition, in the third embodiment, the first depressurizing pump 300 is used as a pump exclusively depressurizing the depressurizing chamber 80.

The printer according to the third embodiment having the above-described configuration has the same advantage as that of the printer 500 according to the first embodiment. In addition, since there are provided the pump exclusively depressurizing the depressurizing pump 80 and the pump exclusively depressurizing the first atmosphere chamber 78, even when one of the pumps is broken, it is possible to perform the bubble removing process in the carriage 100.

### D. Modified Example

In addition, the constituents other than the constituents claimed in the independent claims among the constituents of the above-described embodiments are additional constituents, and may be appropriately omitted. Further, the invention is not limited to the above-described examples or embodiments, but may be modified into various forms within the scope of not departing from the spirit of the invention. For example, the invention may be modified as below.

### D1. Modified Example 1

In the above-described embodiments, the printers 500 and 500a have a configuration in which the bubble removing mechanism (the mechanism including the bubble removing chamber 92, the depressurizing chamber 80, the second pressure chamber 89, the second partition wall portion 88b, the second atmosphere chamber 87, and the second pressure control valve 81) is provided on the downstream side of the first atmosphere chamber 78, but the bubble removing mechanism may not be provided. Even in this case, since the bubble removing process is performed in the first atmosphere chamber 78, it is possible to suppress the growth of the bubbles inside the first atmosphere chamber 78. In addition, the bubble removing mechanism may be provided on the upstream side of the first atmosphere chamber 78 in addition to the downstream side of the first atmosphere chamber 78 or instead of the downstream side of the first atmosphere chamber 78.

### D2. Modified Example 2

In the above-described embodiments, the bubble removing process is performed when the printers 500 and 500a are turned off, but may be performed at a different timing. For example, the bubble removing process may be periodically performed in the state where the printers are turned on. In addition, for example, the bubble removing process may be performed after exchanging the ink cartridge. Further, for example, the bubble removing process may be performed at an arbitrary timing in such a manner that a user starts the bubble removing process by operating an operation panel (not shown) of the printers 500 and 500a.

### D3. Modified Example 3

In the above-described embodiments, the printers 500 and 500a eject four colors of inks, but may eject arbitrary types of inks. In addition, in the above-described embodiments, the printers 500 and 500a are of off-carriage types, but a so-called on-carriage type printer may be adopted in which an ink cartridge is mounted to a carriage.

### D4. Modified Example 4

In the second embodiment, the suction recovery pump 452 is prepared in addition to the first depressurizing pump 300, but the inside of the suction recovery cap 450 may be sucked by using the first depressurizing pump 300. In this case, it is desirable to provide a vale for changing the communication place of the first depressurizing pump 300.

### D5. Modified Example 5

In the above-described embodiments, the operation of opening or closing the switching valve 200 is controlled by the printing control unit 411 or the bubble removing control unit 412, but a user may manually perform the operation of opening or closing the switching valve 200.

### D6. Modified Example 6

In the above-described embodiments, the ink jet printer has been described, but the invention is not limited thereto. That is, the invention may be applied to an arbitrary liquid ejecting apparatus for ejecting a liquid other than ink. For example, the invention may be applied to an image recording apparatus such as a facsimile apparatus, a color material ejecting head used to manufacture a color filter such as a liquid crystal display, an electrode material ejecting device used to form electrodes of an organic EL (Electro Luminescence) display or a FED (Field Emission) display, a liquid ejecting apparatus ejecting a liquid including a biological organic material used to manufacture a biochip, an apparatus ejecting a sample as a precise pipette, an apparatus ejecting lubricant, or an apparatus ejecting a resin liquid. Further, the invention may be applied to a liquid ejecting apparatus ejecting lubricant to a precision machine such as a watch or a camera using a pinpoint, a liquid ejecting apparatus ejecting a transparent resin liquid such as a UV curing resin onto a substrate so as to form a minute semi-spherical lens (optical lens) used in an optical communication element or the like, or a liquid ejecting apparatus ejecting an acid or alkaline etching liquid so as to perform etching on a substrate or the like. In addition, the invention may be applied to any one of the various liquid ejecting apparatuses including a liquid ejecting head and the like for ejecting a minute amount of liquid droplets.

Further, the liquid droplet indicates a state of a liquid ejected from the liquid ejecting apparatus, and includes a particle state, a tear state, and a filamentous state. In addition, the liquid mentioned herein may be a material which may be ejected by the liquid ejecting apparatus. For example, a liquid-state material, a liquid-state material having high or low viscosity, sol, gel water, and a flow-state material such as inorganic solvent, organic solvent, solution, liquid-state resin, and liquid-state metal (melted metal liquid) may be adopted. In addition to a liquid state as one state of a material, a material obtained by melting, dispersing, or mixing a particle of a functional material formed from a solid material such as pigment or metal particle in a solvent may be adopted. In addition, as a typical example of the liquid, the ink or the liquid crystal described in the above-described embodiments may be exemplified. Here, an example of the ink includes general water-based ink and oil-based ink and various liquid compositions such as gel ink and hot-metal ink.

What is claimed is:

1. A bubble removing method of removing bubbles contained in a liquid in a liquid ejecting apparatus including: a liquid storing chamber which stores a liquid, a first pressure control chamber which is adjacent to the liquid storing chamber with a first partition wall portion having flexibility and gas permeability interposed therebetween, a pressure control valve which opens or seals an inlet of the liquid storing chamber in response to displacement of the first partition wall portion, a switching valve which is connected to the first pressure control chamber, a depressurizing pump which is connected to the switching valve, and an ejection port which is disposed on the downstream side of the liquid storing chamber to eject the liquid, the bubble removing method comprising:
communicating the first pressure control chamber with the depressurizing pump by controlling the switching valve;
depressurizing the first pressure control chamber by driving the depressurizing pump; and
sealing the first pressure control chamber by controlling the switching valve.

2. The bubble removing method according to claim 1, further comprising:
sucking the ejection port; and
opening the first pressure control chamber to an atmosphere.
